(19) United States
(12) Patent Application Publication
(10) Pub. No.: US 2002/0005633 A1
(43) Pub. Date: Jan. 17, 2002

(54) Passenger-seat airbag

(76) Inventor: Ichiro Amamori, Tokyo (JP)

Correspondence Address: KANESAKA AND TAKEUCHI, 1423 Powhattan Street, Alexandria, VA, 22314, US

(21) Appl. No.: 09/892,439

(22) Filed: Jun. 28, 2001

(30) Foreign Application Priority Data
Jul. 7, 2000 (JP) 2000-207013

(51) Int. Cl. B60R 21/24

(52) U.S. Cl. 280/729; 280/743.1; 280/739

(57) ABSTRACT

A passenger-seat airbag of the invention has an occupant-facing surface at the front end and a windshield-facing surface on the upper side-face. The occupant-facing surface and the windshield-facing surface are connected together with an internal member. When an inflator is operated for gas-injection, the occupant-facing surface is inflated due to the gas pressure so as to approach an occupant while an intermediate portion in the vertical direction of the windshield-facing surface is pulled by the occupant-facing surface via the internal member so as to form a depressed shape inside the airbag. Thereby, the airbag is reduced in volume so as to promptly complete the inflation even when the inflator has a small output while the occupant-facing surface approaches sufficiently close to the occupant, enabling to receive the occupant promptly.

### BACKGROUND OF THE INVENTION AND RELATED ART STATEMENT

The present invention relates to a passenger-seat airbag which is disposed in an automobile instrument panel to protect an occupant by inflating between a windshield and the occupant in a passenger seat upon an emergency such as a vehicle collision, and more specifically relates to a passenger-seat airbag having means for restricting a final expanded shape of the airbag formed when the airbag is inflated.

In general, a passenger-seat airbag of an automobile is accommodated within a container-like retainer so as to be disposed in an instrument panel and covered with a lid (lid-like member) attached to the retainer. The retainer is provided with an inflator for generating gas to inflate the airbag.

Upon an emergency such as a vehicle collision, the passenger-seat airbag is inflated by gas from the inflator operated for injecting the gas and largely expands into a vehicle cabin by pushing and opening the lid to receive an occupant rapidly moving forwardly due to an impact of the collision, etc.

FIG. 2 is a sectional view of a conventional passenger-seat airbag 100 showing an expanded state thereof.

The passenger-seat airbag 100 has a substantially conical expanded shape tapered toward the rear end (left end viewed in FIG. 2, being identical below) thereof. The front end (right end viewed in FIG. 2, being identical below) of the airbag 100 opposes an occupant when the airbag 100 is inflated upon an emergency such as a vehicle collision so as to form an occupant-facing surface 102 having an area sufficient for receiving the occupant. The upper-side (upper side viewed in FIG. 2, being identical below) face of the airbag 100 forms a windshield-facing surface 104 opposing a windshield 122 in the front of the vehicle when the airbag 100 is inflated.

The periphery of an opening 106 at the rear end of the airbag 100 is connected to the opening periphery in the front side of a container-like retainer 110. Within the retainer 110, an inflator 112 is equipped so that gas injected from the inflator 112 is introduced into the airbag 100 via these openings. The airbag 100 is folded and accommodated into the retainer 110. A lid 114 is attached to the opening of the retainer 110 and the airbag 100 is equipped in an automobile instrument panel 120.

Upon an emergency such as a vehicle collision, the airbag 100 is inflated by gas from the inflator 112 operated for injecting the gas and expands into a vehicle cabin by pushing and opening the lid 114.

The airbag 100 expanded into the vehicle cabin is largely inflated between a windshield 122 of a vehicle body and an occupant. At this time, while the occupant-facing surface 102 is inflated so as to oppose and ready to receive the occupant, the windshield-facing surface 104 is inflated along the windshield 122 so as to oppose the windshield 122. When the occupant impacts the occupant-facing surface 102 so as to urge the airbag 100, the windshield-facing surface 104 is securely held by abutting to the windshield 122 so as to securely receive the occupant.

Since such a passenger-seat airbag requires to be inflated over a wide range so as to securely receive an occupant by filling up a space between the occupant, the vehicle-body windshield, and the instrument panel, the airbag is liable to have a large capacity, so that various means have been taken in order to complete the rapid expansion of such a large-capacity airbag after the beginning of the inflating.

One of such means is to increase the output of the inflator which is a gas generator for inflating the airbag; however, because the large-capacity inflator is expensive and applying a large stress to the airbag and adapters as well, these other members also require high-strength designs, so that the large-capacity inflator is not preferable in cost and weight.

There is therefore an airbag, for example, constructed to promptly complete the expansion after the initiation of the inflation of the airbag even when using a relatively small capacity inflator by reducing the volume of the airbag by connecting between an occupant-facing surface of the airbag and the periphery of an opening for gas-introduction fixed to a retainer at the rear end of the airbag with a strap, etc., so as to restrict the inflation of the occupant-facing surface.

However, when the volume of the airbag is reduced by restricting the inflation of the occupant-facing surface so as to control the expansion of the airbag in such a manner, the distance between the occupant and the occupant-facing surface in a final expanded shape of the airbag would be increased.

It is an object of the present invention to provide a passenger-seat airbag having a sufficient capacity for absorbing an impact when the airbag is expanded and also being capable of completing the expansion promptly without increasing the output of an inflator by solving such the problems.

### SUMMARY OF THE INVENTION

A passenger-seat airbag according to the present invention, which is disposed in an instrument panel and inflates between a windshield and an occupant, comprises a bag, wherein a concave depression which separates the bag from the windshield is formed on a windshield-facing surface of the bag when the bag forms a final expanded shape.

Preferably, a passenger-seat airbag according to the present invention further comprises an internal member connecting the windshield-facing surface to an occupant-facing surface of the bag, wherein the internal member connects the windshield-facing surface to the occupant-facing surface such that the windshield-facing surface is separated from the windshield when the final expanded shape is formed.

According to a passenger-seat airbag of the present invention, when an inflator for inflating the airbag is operated for gas injection to inflate the airbag upon an emergency such as a vehicle collision, an occupant-facing surface of the airbag is inflated toward an occupant due to the gas pressure from the inflator while an intermediate portion of a windshield-facing surface of the airbag, which is connected to the occupant-facing surface via an internal member, is pulled by the occupant-facing surface toward the occupant, for example, and thereby the windshield-facing surface is separated from a windshield so as to sink into the airbag.

Consequently, the volume of the airbag is reduced by the amount spaced from the windshield (inwardly depressed amount) of the upper intermediate portion of the windshield-facing surface, so that the airbag according to the present invention can rapidly complete the inflation even when the output of the inflator is relatively small. Also, the windshield-facing surface, which does not oppose the occupant, is depressed inside the airbag so as to reduce the volume of the airbag, and the occupant-facing surface approaches sufficiently close to the occupant upon completion of the expansion. Accordingly, the occupant is promptly received by the occupant-facing surface in a vehicle collision, so that the occupant can be protected.

In the airbag, upon completion of the expansion, the intermediate portion of the windshield-facing surface is in a concavely depressed state inside the airbag so as to be spaced from the windshield, and the upper part of the airbag is inflated so as to oppose any of the windshield and the occupant. Therefore, even when the occupant impacts and strongly urges the airbag, the upper end of the windshield-facing surface abuts the windshield so as to securely support the airbag, enabling to securely absorb the impact from the occupant.

In the passenger-seat airbag according to the present invention, the internal member may not break even in a final expanded shape to connect between the windshield-facing surface and the occupant-facing surface; however, it may be designed to break when the occupant impacts the inflated airbag, or it may absorb an impact due to the breaking.

### BRIEF DESCRIPTION OF THE DRAWINGS

FIG. 1 is a sectional view of a passenger-seat airbag according to an embodiment of the present invention showing a state of the expansion completion of the airbag; and

FIG. 2 is a sectional view of a conventional passenger-seat airbag showing a state of the expansion completion of the airbag.

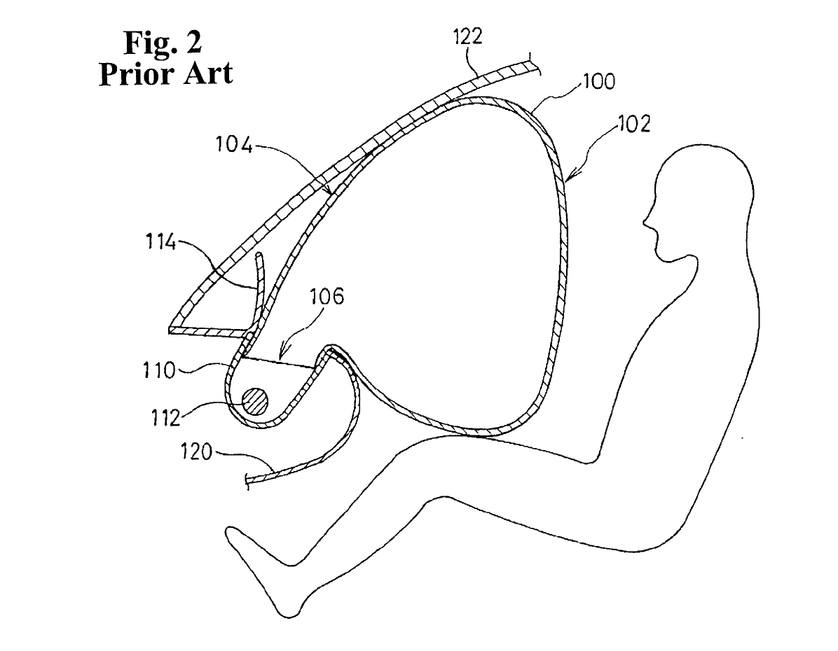

### DESCRIPTION OF PREFERRED EMBODIMENTS

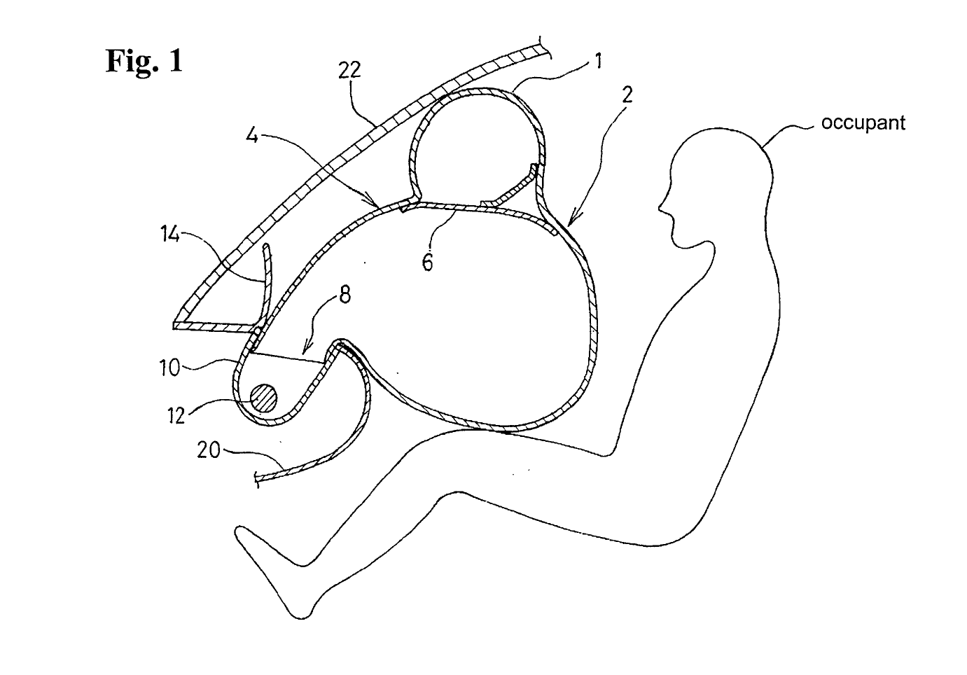

An embodiment according to the present invention will be described below with reference to the drawings. FIG. 1 is a sectional view of a passenger-seat airbag according to the embodiment of the present invention showing a state of the expansion completion of the airbag.

A passenger-seat airbag 1 has a sub stantially conical expanded shape tapered toward the rear end (left end viewed in FIG. 1, being identical below) thereof. The front end (right end viewed in FIG. 1, being identical below)of the airbag 1 in the inflating direction opposes an occupant when the airbag 1 is inflated upon an emergency such as a vehicle collision so as to form an occupant-facing surface 2 having an area sufficient for receiving the occupant. The upper base-end (upper side viewed in FIG. 1, being identical below) face of the airbag 1 forms a windshield-facing surface 4 opposing a windshield 22 in the front of a vehicle when the airbag 1 is inflated.

The occupant-facing surface 2 and the windshield-facing surface 4 are connected together with an internal member 6 so that intermediate portions of these surfaces in the vertical direction are not separated from each other more than a predetermined space.

One end of the internal member 6, which is made from cloth, resin sheet, or the like, is connected to the occupant-facing surface 2 and other end thereof to the windshield-facing surface 4 by connecting means such as stitching, adhesion, and welding, respectively.

In the airbag 1 in which the occupant-facing surface 2 and the windshield-facing surface 4 are connected together with the internal member 6, when an inflator 12 which will be described later is operated for injection, the occupant-facing surface 2 is inflated toward the occupant due to the gas pressure from the inflator 12 while an intermediate portion of the windshield-facing surface 4 in the vertical direction, which is connected to the occupant-facing surface 2, is pulled by the occupant-facing surface 2 toward the occupant via the internal member 6. Upon the expansion completion of the airbag 1, the intermediate portion of the windshield-facing surface 4 is separated from the windshield 22 so that a part of the windshield-facing surface 4 sinks inside the airbag.

The internal member 6 connects between the occupant-facing surface 2 and the windshield-facing surface 4 without breaking even in a final expanded shape. In addition, the internal member 6 is preferably cord-like or band-like so that upper and lower parts of the inside of the airbag 1 than the internal member 6 are usually communicated with each other. When the airbag 1 is inflated due to the gas from the inflator 12, the upper part than the internal member 6 is also inflated promptly.

The periphery of an opening 8 at the rear end of the airbag 1 is connected to the opening periphery in the front side of a container-like retainer 10. Within the retainer 10, the inflator 12 is equipped so that gas injected from the inflator 12 is introduced into the airbag 1 via these openings. The airbag 1 is folded and accommodated into the retainer 10. A lid 14 is attached to the opening of the retainer 10, and in this state, the airbag 1 is equipped in an automobile instrument panel 20.

Upon an emergency such as a vehicle collision, the airbag 1 is inflated by the injected gas from the inflator 12 and expands into a vehicle cabin by pushing and opening the lid 14.

At this time, in the airbag 1, while the occupant-facing surface 2 is promptly inflated toward the occupant by the gas pressure from the inflator 12, an intermediate portion of the windshield-facing surface 4, which is connected to the occupant-facing surface 2 via the internal member 6, is pulled by the occupant-facing surface 2 toward the occupant, so that the airbag 1 expands finally in a shape that a part of the windshield-facing surface 4 sinks inwardly.

Consequently, the volume of the airbag 1 is reduced by the inwardly depressed amount of the intermediate portion of the windshield-facing surface 4, so that the airbag 1 can rapidly complete the inflation sufficiently enough even when the output of the inflator 12 is relatively small. Also, a part of the upper windshield-facing surface 4, which does not oppose the occupant, is depressed inside the airbag so as to reduce the volume of the airbag, and the occupant-facing surface 2 approaches sufficiently close to the occupant upon completion of the expansion. Accordingly, the occupant is promptly received by the occupant-facing surface 2 of the airbag 1 in a vehicle collision, so that the movement distance of the occupant contacting the occupant-facing surface 2 is increased.

In the airbag 1, upon completion of the expansion, the intermediate portion of the windshield-facing surface 4 is in a concavely depressed state inside the airbag; however, the upper end thereof is largely inflated so as to contact the windshield 22, so that even when the occupant impacts and strongly urges the airbag 1, the upper end of the windshield-facing surface 4 abuts the windshield 22 so as to securely support the airbag 1 applying a sufficient reaction force to the airbag 1.

Thereby, an impact applied to an occupant can be sufficiently absorbed by the airbag 1.

In addition, the internal member 6 is not limited to be band-like or cord-like; however, it may be a panel having an opening or the like.

In the above-described embodiment, the internal member 6 does not break; however, it may break when an occupant impacts the inflated airbag 1, or it may absorb an impact due to the breaking.

As described above, according to the passenger-seat airbag of the present invention, the volume of the airbag can be reduced while sufficiently maintaining the impact-absorbing capacity of the airbag. Even when using a small capacity inflator, the expansion of the airbag is promptly completed while the occupant-facing surface expands in the wide range so as to securely protect an occupant.

What is claimed is:

1. A passenger-seat airbag for mounting in a vehicle for inflation between a windshield and an occupant, comprising a bag, said bag having a concave depression which separates the bag from the windshield formed on a windshield-facing surface of the bag when the bag is fully inflated.

2. A passenger-seat airbag according to claim 1, wherein said bag comprises a windshield-facing surface and an occupant facing surface, and an internal member connecting the windshield-facing surface to the occupant-facing surface whereby the windshield-facing surface is separated from the windshield when the bag is fully inflated.

3. A passenger-seat airbag according to claim 2, wherein the internal member connecting the windshield-facing surface to the occupant-facing surface has sufficient strength so as not to break even when the final expanded shape is formed.

4. A passenger-seat airbag according to claim 2, wherein the internal member breaks when the occupant impacts the inflated bag.

5. A passenger-seat airbag according to claim 4, wherein the internal member absorbs an impact by being broken.

6. A passenger-seat airbag for mounting in a vehicle for inflation between the vehicle windshield and a vehicle passenger, comprising
an inflatable bag having a windshield-facing surface and a passenger-facing surface when inflated, and
volume-reducing means in said inflatable bag, said volume reducing means including a flexible member joining said windshield-facing and said passenger-facing surfaces for dividing the interior of said inflatable bag into an upper and a lower chamber so that when said inflatable bag is inflated, said upper chamber is positioned to engage the vehicle windshield and said lower chamber is spaced from the windshield.

7. A passenger-seat airbag as claimed in claim 6, wherein said volume-reducing means comprises an air-permeable flexible panel.

8. A passenger-seat airbag as claimed in claim 7, wherein said flexible panel is a fabric panel.

9. A passenger-seat air bag as claimed in claim 6, wherein said flexible member restrains said windshield-facing surface to form a depression therein which separates at least a portion of said windshield-facing surface from the vehicle windshield when said inflatable bag is fully inflated.
